(19) United States
(12) Patent Application Publication
(10) Pub. No.: US 2014/0362052 A1
(43) Pub. Date: Dec. 11, 2014

(54) Touch Sensitive Image Display Devices

(71) Applicant: Light Blue Optics Ltd, Cambridge (GB)

(72) Inventors: Gareth John McCaughan, Cambridge (GB); Adrian James Cable, Cambridge (GB); Euan Christopher Smith, Longstanton (GB); Paul Richard Routley, Longstanton (GB); Raul Benet Ballester, Cambridge (GB)

(21) Appl. No.: 14/369,085

(22) PCT Filed: Jan. 17, 2013
(86) PCT No.: PCT/GB2013/050104

§ 371 Date: Jun. 26, 2014

(30) Foreign Application Priority Data
Jan. 20, 2012 (GB) 1200965.0
Jan. 20, 2012 (GB) 1200968.4

(51) Int. Cl. G06F 3/042

(52) U.S. Cl. CPC G06F 3/0421; G06F 3/0425
USPC 345/175

(57) ABSTRACT

We describe a touch sensitive image display device. The device comprises: an image projector to project a displayed image onto a surface in front of the device; a touch sensor light source to project light defining a touch sheet above the displayed image; a camera directed to capture a touch sense image comprising light scattered from the touch sheet by an object approaching the displayed image; and a signal processor to process a the touch sense image to identify a location of the object relative to the displayed image. The camera is able to capture an image projected by the image projector, the image projector is configured to project a calibration image, and the device includes a calibration module configured to use a calibration image from the projector, captured by the camera, to calibrate locations in said captured touch sense image with reference to said displayed image.

### CROSS REFERENCE TO RELATED APPLICATION

This application claims priority to PCT Application No. PCT/GB2013/050104 entitled “Touch Sensitive Image Display Devices” and filed Jan. 17, 2013. The aforementioned PCT Application in turn claims priority to Great Britain Patent Nos. GB1200968.4 and GB1200965.0 both filed Jan. 20, 2012. The entirety of each the aforementioned applications is incorporated herein by reference for all purposes.

### FIELD OF THE INVENTION

This invention relates to touch sensitive image display devices of the type which project a sheet of light adjacent the displayed image. Some embodiments of the invention relate to techniques for calibration and synchronization between captured touch images and the projected displayed image. Other embodiments of the invention relate to touch image capture and processing techniques.

### BACKGROUND OF THE INVENTION

Background prior art relating to touch sensing systems employing a plane or sheet of light can be found in U.S. Pat. No. 6,281,878 (Montellese), and in various later patents of Lumio/VKB Inc, such as U.S. Pat. No. 7,305,368, as well as in similar patents held by Canesta Inc, for example U.S. Pat. No. 6,710,770. Broadly speaking these systems project a fan-shaped plane of infrared (IR) light just above a displayed image and use a camera to detect the light scattered from this plane by a finger or other object reaching through to approach or touch the displayed image.

Further background prior art can be found in: WO01/93006; U.S. Pat. No. 6,650,318; U.S. Pat. No. 7,305,368; U.S. Pat. No. 7,084,857; U.S. Pat. No. 7,268,692; U.S. Pat. No. 7,417,681; U.S. Pat. No. 7,242,388 (US2007/222760); US2007/019103; WO01/93006; WO01/93182; WO2008/038275; US2006/187199; U.S. Pat. No. 6,614,422; U.S. Pat. No. 6,710,770 (US2002021287); U.S. Pat. No. 7,593,593; U.S. Pat. No. 7,599,561; U.S. Pat. No. 7,519,223; U.S. Pat. No. 7,394,459; U.S. Pat. No. 6,611,921; U.S. Pat. No. D595,785; U.S. Pat. No. 6,690,357; U.S. Pat. No. 6,377,238; U.S. Pat. No. 5,767,842; WO2006/108443; WO2008/146098; U.S. Pat. No. 6,367,933 (WO00/21282); WO02/101443; U.S. Pat. No. 6,491,400; U.S. Pat. No. 7,379,619; US2004/0095315; U.S. Pat. No. 6,281,878; U.S. Pat. No. 6,031,519; GB2,343,023A; U.S. Pat. No. 4,384,201; DE 41 21 180A; and US2006/244720.

We have previously described techniques for improved touch sensitive holographic displays, for example in our earlier patent applications: WO2010/073024; WO2010/073045; and WO2010/073047.

The inventors have continued to develop and advance touch sensing techniques suitable for use with these and other image display systems. In particular we will describe techniques which synergistically link the camera and image projector, and techniques which are useful for providing large area touch-sensitive displays such as, for example, an interactive whiteboard.

### BRIEF DESCRIPTION OF THE DRAWINGS

These and other aspects of the invention will now be further described, by way of example only, with reference to the accompanying figures in which:

FIGS. 1a and 1b show, respectively, a vertical cross section view through an example touch sensitive image display device suitable for implementing embodiments of the invention, and details of a sheet of light-based touch sensing system for the device;

FIGS. 2a and 2b show, respectively, a holographic image projection system for use with the device of FIG. 1, and a functional block diagram of the device of FIG. 1;

FIGS. 3a to 3e show, respectively, an embodiment of a touch sensitive image display device according to an aspect of the invention, use of a crude peak locator to find finger centroids, and the resulting finger locations;

FIGS. 4a and 4b show, respectively, a plan view and a side view of an interactive whiteboard incorporating a touch sensitive image display with a calibration system an embodiment of the invention;

FIGS. 5a to 5d show, respectively, a shared optical configuration for a touch sensitive image display device according to an embodiment of the invention, an alternative shared optical configuration for the device, a schematic illustration of an example of a spatially patterned filter for use in embodiments of the device, and details of a calibration signal processing and control system for the device;

FIGS. 6a to 6c show, respectively, a plan view and a side view of an interactive whiteboard incorporating movement compensation systems according to embodiments of the invention, and a schematic illustration of an artifact which can arise in the arrangement of FIGS. 4a and 4b without movement compensation; and

FIG. 7 shows details of image processing in an embodiment of a touch sensitive image display device according to the invention.

### BRIEF SUMMARY OF THE INVENTION

Some embodiments of the present invention provide a touch sensitive image display device. The device includes an image projector to project a displayed image onto a display surface; the touch sensor light source to project light defining a touch sheet above said displayed image; a camera directed to capture a touch sense image from a region including at least a portion of said touch sheet, said touch sense image comprising light scattered from said touch sheet by an object approaching said displayed image; and a signal processor coupled to said camera, to process a said touch sense image from said camera to identify a location of said object relative to said displayed image. The camera is further able to capture an image projected by said image projector. The image projector is configured to project a calibration image. The touch sensitive image display device further comprises a calibration module configured to use a camera image, captured by said camera, of said calibration image to calibrate locations in said captured touch sense image with reference to said displayed image.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### DETAILED DESCRIPTION

### Calibration and Synchronization

According to a first aspect of the invention there is therefore provided a touch sensitive image display device, the device comprising: an image projector to project a displayed image onto a surface in front of the device; a touch sensor light source to project a sheet of light above said displayed image; a camera directed to capture a touch sense image from a region including at least a portion of said sheet of light, said touch sense image comprising light scattered from said sheet of light by an object approaching said displayed image; and a signal processor coupled to said camera, to process a said touch sense image from said camera to identify a location of said object relative to said displayed image; wherein said camera is further able to capture an image projected by said image projector; wherein said image projector is configured to project a calibration image; and wherein said touch sensitive image display device further comprises a calibration module configured to use a camera image, captured by said camera, of said calibration image to calibrate locations in said captured touch sense image with reference to said displayed image.

It is desirable to be able to calibrate positions within a captured touch sense image with respect to the displayed image without the need for user intervention for example to touch the calibration image to define particular positions. For example embodiments of the invention address this by enabling the camera to see light from the image projector—although this is not straightforward because in general when capturing a touch sense image it is desirable to suppress both background (typically IR, infra red) illumination from the projector, and background visible light, as much as possible.

In some embodiments, therefore, the camera is provided with a filter to suppress light from the displayed image and to allow through only light from the touch sheet. Thus preferably the light defining the touch sheet is substantially monochromatic, for example IR at around 900 nm, and this is selected by means of a notch filter. In embodiments, however, this filter is switchable and may be removed from the optical path to the camera, for example mechanically, to enable the camera to “see” the visible light from the image projector and hence auto-calibrate. In various implementations, therefore, the system is provide with a calibration module which is configured to control a wavelength-dependent sensitivity of the camera, for example by switching a notch filter in or out, and to control the projector to project a calibration image when the notch filter is removed.

In an alternative approach, described further later, the camera may be controlled so as not to see the displayed image in normal operation by controlling a relative timing of the capturing of the touch sense image and displaying of the projected image. More particularly for many types of projector a color image is defined by projecting a sequence of color planes (red, green and blue and potentially white and/or additional colors), modulating these with a common imaging device such as an LCD display or DMD (Digital Micromirror Device). In such a system a natural blanking interval between illumination of the imaging device with the separate color planes may be exploited to capture a touch sense image and/or such a blanking interval may be extended for a similar purpose. In such a system an IR-selective filter may not be needed although optionally a switchable such filter may nonetheless be incorporated into the optical path to the camera. This can be helpful because in the “blanking intervals” there may still be some IR present.

In a still further approach, again in a system which employs an imaging device sequentially illuminated by different color planes, for example employing a color wheel in front of an arc light, the image projector may be modified to include an additional, non-visible (typically IR) illumination option so that if desired the image projector may project a calibration image at substantially the same wavelength as used to generate the touch sheet. In a color wheel type arrangement this may be achieved by including an additional infrared “color” but additionally or alternatively the projector may incorporate a switchable IR illumination source able to illuminate the imaging device (and preferably a control arrangement to, at the same time, switch off the visible illumination).

In a still further approach, which may be employed separately or in combination with the above described techniques, the camera may be provided with a spatially patterned wavelength-selective filter so that some portions of the image sensor see visible light for calibration purposes and other portions see non-visible light, typically IR light, scattered from the touch sheet. One example of such a filter is a checkerboard pattern type filter similar to a Bayer filter. This approach is, however, less preferable because there is a loss in both sensitivity and resolution in both the visible and the IR, although potentially the visible-sensitive pixels may also be employed for other purposes, such as ambient light correction. Where a spatially patterned wavelength-selective filter is employed, it can be preferable also to include an anti-aliasing filter before the camera sensor as this helps to mitigate the potential effects of loss of resolution, broadly speaking by blurring small features.

In some implementations the camera and the image projector share at least part of their front-end image projection/capture optics. This facilitates alignment and helps to maintain calibration, as well as reducing the effects of, for example, different distortion correction being applied to the projected and captured images.

In a related aspect the invention provides a method of calibrating a touch sensitive image display device, the method comprising displaying an image by: projecting a displayed image onto a surface in front of the device using an image projector; projecting a sheet of IR light above said displayed image; capturing a touch sense image from a region including at least a portion of said sheet of light, said touch sense image comprising light scattered from said sheet of light by an object approaching said displayed image using a camera with an IR filter to admit said scattered light and reject light from said displayed image; and processing said touch sense image to identify a location of said object relative to said displayed image; the method further comprising: projecting a calibration image using said image projector; capturing said calibration image using said camera; and calibrating said location of said object with reference to said reference image using said captured calibration image.

In a further aspect the invention provides a touch sensitive image display device, the device comprising: an image projector to project a displayed image onto a surface in front of the device; a touch sensor light source to project a sheet of light above said displayed image; a camera directed to capture a touch sense image from a region including at least a portion of said sheet of light, said touch sense image comprising light scattered from said sheet of light by an object approaching said displayed image; and a signal processor coupled to said camera, to process a said touch sense image from said camera to identify a location of said object relative to said displayed image; wherein said image projector is configured to project said displayed image as a set of sequential sub-frames, at a sub-frame rate, wherein said sub-frames combine to give the visual impression of said displayed image; and wherein capture of said touch sense images is synchronized to said sub-frame projection.

The sub-frames typically comprise color planes sequentially illuminating an imaging device such as a liquid crystal display or digital micro minor device (DMD), for example by means of a color wheel in front of a source of broadband illumination, switched LEDs or lasers or the like. However in the case of an inherently binary imaging device such as a high speed DMD, the sub-frames may include separate binary bit planes for each color, for example to display sequentially a most significant bit plane down to a least significant bit plane. By synchronizing the touch image capture to the sub-frame projection, more particularly so that touch images are captured during a blanking interval between sub-frames, background light interference from the projector can be suppressed.

In a related aspect the invention provides a touch sensitive image display device, the device comprising: an image projector to project a displayed image onto a surface in front of the device; a touch sensor light source to project a sheet of light above said displayed image; a camera directed to capture a touch sense image from a region including at least a portion of said sheet of light, said touch sense image comprising light scattered from said sheet of light by an object approaching said displayed image; and a signal processor coupled to said camera, to process a said touch sense image from said camera to identify a location of said object relative to said displayed image; wherein said image projector is configured to project said displayed image as a set of sequential sub-frames, at a sub-frame rate, wherein said sub-frames combine to give the visual impression of said displayed image; and wherein capture of said touch sense images operates at a frequency different by a factor of at least ten from said sub-frame rate.

In embodiments by selecting the sub-frame rate and touch image capture rate to be at very different frequencies then detected light interference will very rapidly and at a known frequency dependent on the difference between the two rates. Then, because the frequency of the interference is known, this may then be suppressed by filtering for example during digital signal processing of the captured images.

In a further aspect the invention provides a touch sensitive image display device, the device comprising: an image projector to project a displayed image onto a surface in front of the device; a touch sensor light source to project a plane of light above said displayed image; a camera directed to capture a touch sense image from a region including at least a portion of said plane of light, said touch sense image comprising light scattered from said plane of light by an object approaching said displayed image; and a signal processor coupled to said camera, to process a said touch sense image from said camera to identify a location of said object relative to said displayed image; wherein said image projector is configured to project onto said surface at an acute angle and comprises an imaging device illuminated by a display light source, and distortion correction optics between said imaging device and a light projection output of said image projector; wherein said image capture optics are configured to capture said touch sense image from an acute angle relative to said sheet of light; and wherein an optical path between said imaging device and said distortion correction optics includes a dichroic beam splitter to optically couple said camera into a shared optical path for both said projector and said camera through said distortion correction optics to said light projection output.

In embodiments, sharing part of the front end optical path between the image projector and the camera helps with accurate calibration although can potentially increase the level of background light interference from the projector. Thus some implementations also include a broadband IR reject filter between the imaging device and the dichroic beam splitter (unless the imaging device is itself illuminated with substantially monochromatic light for each color). It is further preferable that between the dichroic beam splitter and the camera. Preferably this latter optical path also includes relay optics comprising a magnifying telescope.

Since in general accurate rendition of the displayed image is more important than precise location of a touch position, preferably the distortion correction optics are optimized, more particularly have a focus optimized, for a visible wavelength, that is in a range 400 nm to 700 nm. The relay optics, however, may be optimized for the monochromatic IR touch sheet wavelength. For related reasons it may be desirable to duplicate some of the projection optics, in particular intermediate, aspheric optics between the output, distortion correction optics and the imaging device. Thus in embodiments the dichroic beam splitter may be located between these aspheric optics and the output distortion correction optics and a second set of intermediate, aspheric optics, optimized for the IR touch sheet wavelength, provided between the dichroic beam splitter and the camera.

In some implementations the imaging device is a digital micro mirror imaging device (DMD) although other devices, for example a reflective or transmissive LCD display may also be employed.

In embodiments of the device the image of the scattered light on an image sensor of the camera is defocused. This reduces the effects of laser speckle when laser illumination is used to generate the touch sheet (in embodiments, a plane of light), and also facilitates detection of small touch objects. In embodiments the defocus may be greater along one axis in a lateral plane of the sensor than another, more particularly the defocus may be greater on a vertical axis than on a horizontal axis, where the vertical axis defines a direction of increasing distance from the camera and the horizontal axis a lateral width of the touch sheet. The degree of defocus, that is the extent to which the camera image sensor is displaced away from a focal point or plane may be greater than 1%, 2%, 5%, 10%, 15% or 20% of the focal length to the camera image sensor. The skilled person will appreciate that this technique may be employed independently of the other, previously described aspects and embodiments of the invention.

Embodiments of each of the above described aspects of the invention may be used in a range of touch-sensing display applications. However embodiments the invention are particularly useful for large area touch coverage, for example in interactive whiteboard or similar applications. In embodiments calibration is preferably achieved directly and automatically from a picture of the calibration image recorded by the touch camera without the need to touch a calibration image during projector setup.

### Touch Image Capture and Processing

According to a further aspect of the invention there is therefore provided a touch sensitive image display device, the device comprising: an image projector to project a displayed image onto a display surface; a touch sensor light source to project a light defining a touch sheet above said displayed image; a camera directed to capture a touch sense image from a region including at least a portion of said touch sheet, said touch sense image comprising light scattered from said touch sheet by an object approaching said displayed image; and a signal processor coupled to said camera, to process a said touch sense image from said camera to identify a location of said object relative to said displayed image; and further comprising a movement compensation system to compensate for relative movement between said camera and said display surface.

In particular with large area displays/touch surfaces, for example in an interactive whiteboard application, there can be a problem with wobble of the touch image sensing camera with respect to the display surface. In a typical interactive whiteboard application the camera and projector are co-located and may share some of the front end optics so that the projected image and camera move together. However because both these are generally mounted at some distance from the whiteboard, for example, up to around 0.5 m, in order to be able to project over the whole surface without undue distortion/optical correction, the camera and projected image may move or wobble together with respect to, say, a finger on the display surface. Such motion may be caused, for example, by a person walking past, local air flow and the like. Embodiments of the invention therefore provide a movement compensation system to compensate for relative movement between the camera (and projector) and the display surface.

The motion compensation may be applied at one or more stages of the processing: for example it may be applied to a captured touch sense image or to an image derived from this, and/or to an image such as a calibration image subtracted from the captured touch sense image, for example to provide background compensation, and/or to the detected object location or locations (in a multi touch system), in the latter case applying the motion compensation as part of a motion tracking procedure and/or to a final output of object (finger/pen) position.

In one implementation the camera and/or projector incorporates a motion sensor, for example a MEMS (Micro Electro Mechanical System) gyroscope or accelerometer which is used to effectively stabilize the captured touch sense image with respect to the projected image. Alternatively, however, a non-MEMS motion sensor may be employed, for example a regular gyroscope or accelerometer.

Additionally or alternatively some embodiments of the device use the light defining the touch sheet, generated by the touch sensing system, to project a visible or invisible template for use in one or both of motion compensation for touch image stabilization and improved ambient/spilled light rejection as described later. Thus embodiments of the device make use of projections or other features associated with the display surface which intersect the light defining the touch sheet, in embodiments a plane of light, and provide one or more fiducial positions which may then be used for motion tracking/compensation.

For example in an interactive whiteboard application such features may comprise one or more projections from the board and/or a border around part of the board and/or features which are already present and used for other purposes, for example a pen holder or the like. These provide essentially fixed features which can be used for motion tracking/compensation and other purposes.

Some implementations also incorporate a system to attenuate fixed pattern camera noise from a captured image. This may either be applied to a captured image of the input template (illuminated features) or to a motion-compensated background calibration image to be subtracted from a touch sensing image before further processing, or both. Broadly speaking the fixed noise pattern or the camera sensor scales with exposure time (unlike other noise) and thus the fixed pattern noise can be identified by subtracting two images with different exposures. This fixed pattern camera noise may then be used to improve the quality of a captured touch sense image by compensating for this noise. The skilled person will appreciate that, potentially, this technique may be employed independently of the other techniques described herein.

With a large area display surface such as an interactive whiteboard there can sometimes be areas of diffuse reflected ambient light and/or areas in which light from the light sheet spills onto the display surface. A simple subtraction of this from a captured touch sense image does not produce a good result because the camera-projector position can have a small swing or wobble. Thus in embodiments the signal processor includes a masking module to apply and mask to either or both of (an image derived from) the captured touch sense image, and a location of a detected object, to reject potential touch events outside the mask. The size and/or location of the mask may be determined from the input template which may comprise, for example, a bezel surrounding the whiteboard area.

In a related aspect the invention also provides a signal processor for use with the above described aspects/embodiments of the invention. As the skilled person will appreciate, functional modules of this signal processor may be implemented in software, in hardware, or in a combination of the two. For example one implementation may employ some initial hardware-based processing followed by subsequent software-defined algorithms.

The invention also provides a method of touch sensing in a touch sensitive image display device, the method comprising: projecting a displayed image onto a surface; projecting a light defining a touch sheet above said displayed image; capturing a touch sense image from a region including at least a portion of said touch sheet, said touch sense image comprising light scattered from said touch sheet by an object approaching said displayed image; and processing said touch sense image to identify a location of said object relative to said displayed image; the method further comprising compensating for relative movement between said camera and said display surface.

In a further, related aspect the invention provides a touch sensitive image display device, the device comprising: an image projector to project a displayed image onto a display surface; a touch sensor light source to project a light defining a touch sheet above said displayed image; a camera directed to capture a touch sense image from a region including at least a portion of said touch sheet, said touch sense image comprising light scattered from said touch sheet by an object approaching said displayed image; and a signal processor coupled to said camera, to process a said touch sense image from said camera to identify a location of said object relative to said displayed image; wherein said signal processor further comprises an input template detection module configured to detect an input template projected onto said display surface by said touch sensor light source; and a masking module to apply a mask to one or both of an image from said camera and a said location of said object to reject putative touch events outside said mask; and wherein said signal processor is configured to determine a location for said mask location responsive to said detected input template.

The invention still further provides a method of rejecting one or both of reflected ambient light and light spill from a touch sensor light source in a touch sensitive image display device, the touch sensitive image display device comprising: an image projector to project a displayed image onto a display surface; a touch sensor light source to project light defining a touch sheet above said displayed image; a camera directed to capture a touch sense image from a region including at least a portion of said touch sheet, said touch sense image comprising light scattered from said touch sheet by an object approaching said displayed image; and a signal processor coupled to said camera, to process a said touch sense image from said camera to identify a location of said object relative to said displayed image; the method comprising: using said light defining said touch sheet to illuminate one or more features projecting from said display surface to thereby define an input template; using a location of said input template to define a mask to apply to one or both of an image captured from said camera and a said identified object location; and applying said mask to one or both of an image captured from said camera and a said identified object location to reject one or both of reflected ambient light and light spill onto said display surface from said light defining said touch sheet.

Embodiments of each of the above described aspects of the invention may be used in a range of touch-sensing display applications. However embodiments the invention are particularly useful for large area touch coverage, for example in interactive whiteboard or similar applications.

Embodiments of each of the above described aspects of the invention are not limited to use with any particular type of projection technology. Thus although we will describe later an example of a holographic image projector, the techniques of the invention may also be applied to other forms of projection technology including, but not limited to, digital micro mirror-based projectors such as projectors based on DLP Light Processing) technology from Texas Instruments, Inc.

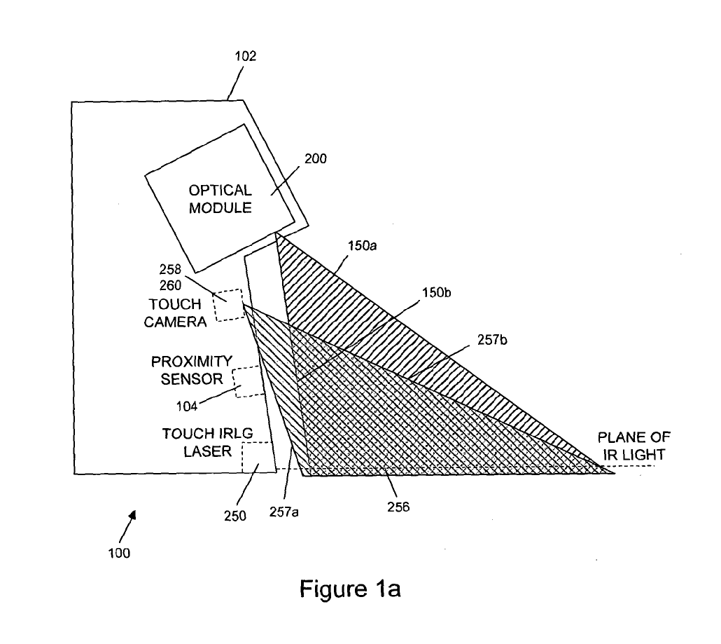

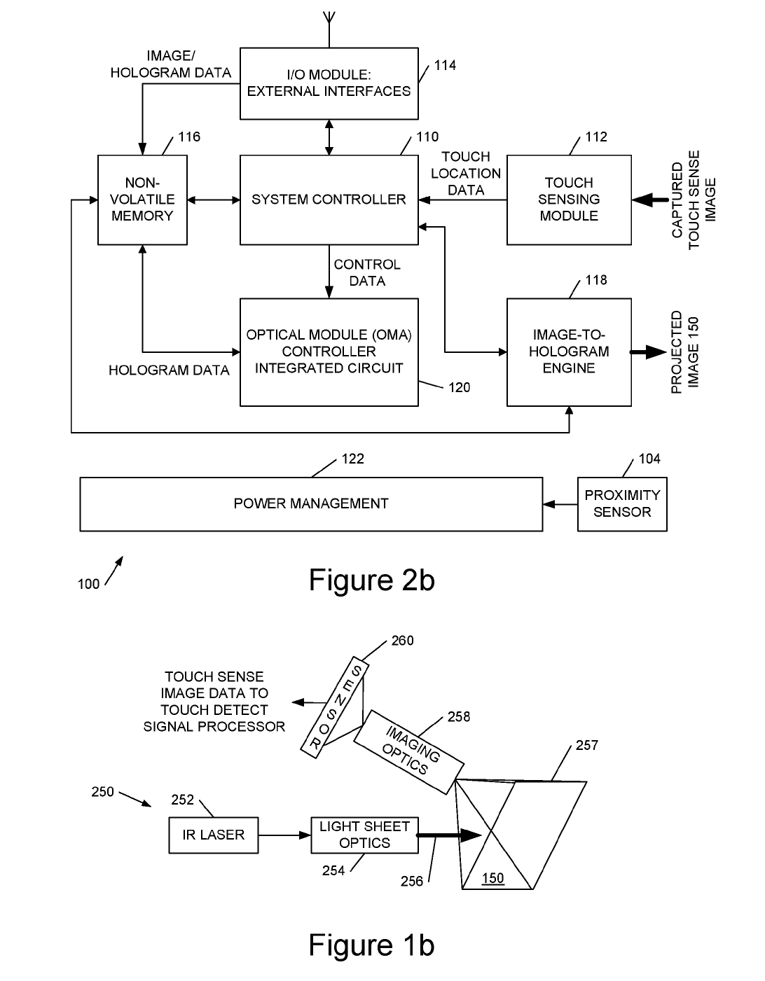

FIGS. 1a and 1b show an example touch sensitive holographic image projection device 100 comprising a holographic image projection module 200 and a touch sensing system 250, 258, 260 in a housing 102. A proximity sensor 104 may be employed to selectively power-up the device on detection of proximity of a user to the device.

A holographic image projector is merely described by way of example; the techniques we describe herein may be employed with any type of image projection system.

The holographic image projection module 200 is configured to project downwards and outwards onto a flat surface such as a tabletop. This entails projecting at an acute angle onto the display surface (the angle between a line joining the centre of the output of the projection optics and the middle of the displayed image and a line in a plane of the displayed image is less than) 90°. We sometimes refer to projection onto a horizontal surface, conveniently but not essentially non-orthogonally, as “table down projection”. A holographic image projector is particularly suited to this application because it can provide a wide throw angle, long depth of field, and substantial distortion correction without significant loss of brightness/efficiency. Boundaries of the light forming the displayed image 150 are indicated by lines 150a, b.

The touch sensing system 250, 258, 260 comprises an infrared laser illumination system (IR line generator) 250 configured to project a sheet of infrared light 256 just above, for example ˜1 mm above, the surface of the displayed image 150 (although in principle the displayed image could be distant from the touch sensing surface). The laser illumination system 250 may comprise an IR LED or laser 252, preferably collimated, then expanded in one direction by light sheet optics 254, which may comprise a negative or cylindrical lens. Optionally light sheet optics 254 may include a 45 degree mirror adjacent the base of the housing 102 to fold the optical path to facilitate locating the plane of light just above the displayed image.

A CMOS imaging sensor (touch camera) 260 is provided with an it-pass lens 258 captures light scattered by touching the displayed image 150, with an object such as a finger, through the sheet of infrared light 256. The boundaries of the CMOS imaging sensor field of view are indicated by lines 257, 257a,b. The touch camera 260 provides an output to touch detect signal processing circuitry as described further later.

### Example Holographic Image Projection System

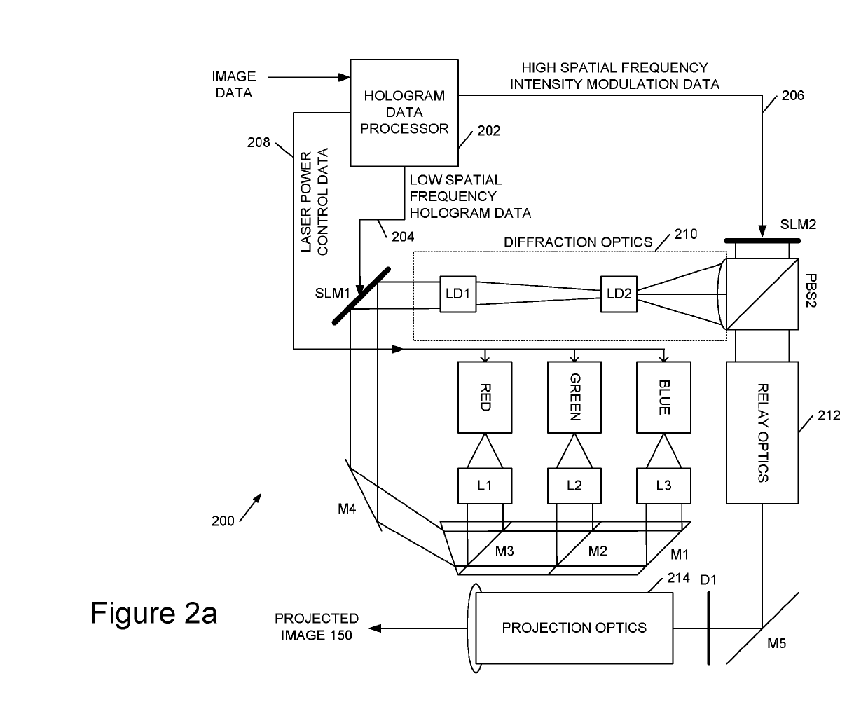

FIG. 2a shows an example holographic image projection system architecture 200 in which the SLM may advantageously be employed. The architecture of FIG. 2 uses dual SLM modulation-low resolution phase modulation and higher resolution amplitude (intensity) modulation. This can provide substantial improvements in image quality, power consumption and physical size. The primary gain of holographic projection over imaging is one of energy efficiency. Thus the low spatial frequencies of an image can be rendered holographically to maintain efficiency and the high-frequency components can be rendered with an intensity-modulating imaging panel, placed in a plane conjugate to the hologram SLM. Effectively, diffracted light from the hologram SLM device (SLM1) is used to illuminate the imaging SLM device (SLM2). Because the high-frequency components contain relatively little energy, the light blocked by the imaging SLM does not significantly decrease the efficiency of the system, unlike in a conventional imaging system. The hologram SLM is preferably be a fast multi-phase device, for example a pixellated MEMS-based piston actuator device.

In FIG. 2a:
SLM1 is a pixellated MEMS-based piston actuator SLM as described above, to display a hologram—for example a 160×160 pixel device with physically small lateral dimensions, e.g <5 mm or <1 mm.
L1, L2 and L3 are collimation lenses (optional, depending upon the laser output) for respective Red, Green and Blue lasers.
M1, M2 and M3 are dichroic mirrors a implemented as prism assembly.
M4 is a turning beam minor.
SLM2 is an imaging SLM and has a resolution at least equal to the target image resolution (e.g. 854×480); it may comprise a LCOS (liquid crystal on silicon) or DMD (Digital Micromirror Device) panel.
Diffraction optics 210 comprises lenses LD1 and LD2, forms an intermediate image plane on the surface of SLM2, and has effective focal length f such that fλ/Δ covers the active area of imaging SLM2. Thus optics 210 perform a spatial Fourier transform to form a far field illumination pattern in the Fourier plane, which illuminates SLM2.
PBS2 (Polarizing Beam Splitter 2) transmits incident light to SLM2, and reflects emergent light into the relay optics 212 (liquid crystal SLM2 rotates the polarization by 90 degrees). PBS2 preferably has a clear aperture at least as large as the active area of SLM2.
Relay optics 212 relay light to the diffuser D1.
M5 is a beam turning mirror.
D1 is a diffuser to reduce speckle.
Projection optics 214 project the object formed on D1 by the relay optics 212, and preferably provide a large throw angle, for example >90°, for angled projection down onto a table top (the design is simplified by the relatively low entendue from the diffuser).

The different colors are time-multiplexed and the sizes of the replayed images are scaled to match one another, for example by padding a target image for display with zeros (the field size of the displayed image depends upon the pixel size of the SLM not on the number of pixels in the hologram).

A system controller and hologram data processor 202, implemented in software and/or dedicated hardware, inputs image data and provides low spatial frequency hologram data 204 to SLM1 and higher spatial frequency intensity modulation data 206 to SLM2. The controller also provides laser light intensity control data 208 to each of the three lasers. For details of an example hologram calculation procedure reference may be made to WO2010/007404 (hereby incorporated by reference).

### Control System

Referring now to FIG. 2b, this shows a block diagram of the device 100 of FIG. 1. A system controller 110 is coupled to a touch sensing module 112 from which it receives data defining one or more touched locations on the display area, either in rectangular or in distorted coordinates (in the latter case the system controller may perform keystone distortion compensation). The touch sensing module 112 in embodiments comprises a CMOS sensor driver and touch-detect processing circuitry.

The system controller 110 is also coupled to an input/output module 114 which provides a plurality of external interfaces, in particular for buttons, LEDs, optionally a USB and/or Bluetooth® interface, and a bi-directional wireless communication interface, for example using WiFi®. In embodiments the wireless interface may be employed to download data for display either in the form of images or in the form of hologram data. In an ordering/payment system this data may include price data for price updates, and the interface may provide a backhaul link for placing orders, handshaking to enable payment and the like. Non-volatile memory 116, for example Flash RAM is provided to store data for display, including hologram data, as well as distortion compensation data, and touch sensing control data (identifying regions and associated actions/links). Non-volatile memory 116 is coupled to the system controller and to the 110 module 114, as well as to an optional image-to-hologram engine 118 as previously described (also coupled to system controller 110), and to an optical module controller 120 for controlling the optics shown in FIG. 2a. (The image-to-hologram engine is optional as the device may receive hologram data for display from an external source). In embodiments the optical module controller 120 receives hologram data for display and drives the hologram display SLM, as well as controlling the laser output powers in order to compensate for brightness variations caused by varying coverage of the display area by the displayed image (for more details see, for example, our WO2008/075096). In embodiments the laser power(s) is(are) controlled dependent on the “coverage” of the image, with coverage defined as the sum of: the image pixel values, preferably raised to a power of gamma (where gamma is typically 2.2). The laser power is inversely dependent on (but not necessarily inversely proportional to) the coverage; in embodiments a lookup table as employed to apply a programmable transfer function between coverage and laser power. The hologram data stored in the non-volatile memory, optionally received by interface 114, therefore in embodiments comprises data defining a power level for one or each of the lasers together with each hologram to be displayed; the hologram data may define a plurality of temporal holographic sub frames for a displayed image. Various embodiments of the device also include a power management system 122 to control battery charging, monitor power consumption, invoke a sleep mode and the like.

In operation the system controller controls loading of the image/hologram data into the non-volatile memory, where necessary conversion of image data to hologram data, and loading of the hologram data into the optical module and control of the laser intensities. The system controller also performs distortion compensation and controls which image to display when and how the device responds to different “key” presses and includes software to keep track of a state of the device. The controller is also configured to transition between states (images) on detection of touch events with coordinates in the correct range, a detected touch triggering an event such as a display of another image and hence a transition to another state. The system controller 110 also, in embodiments, manages price updates of displayed menu items, and optionally payment, and the like.

### Touch Sensing Systems

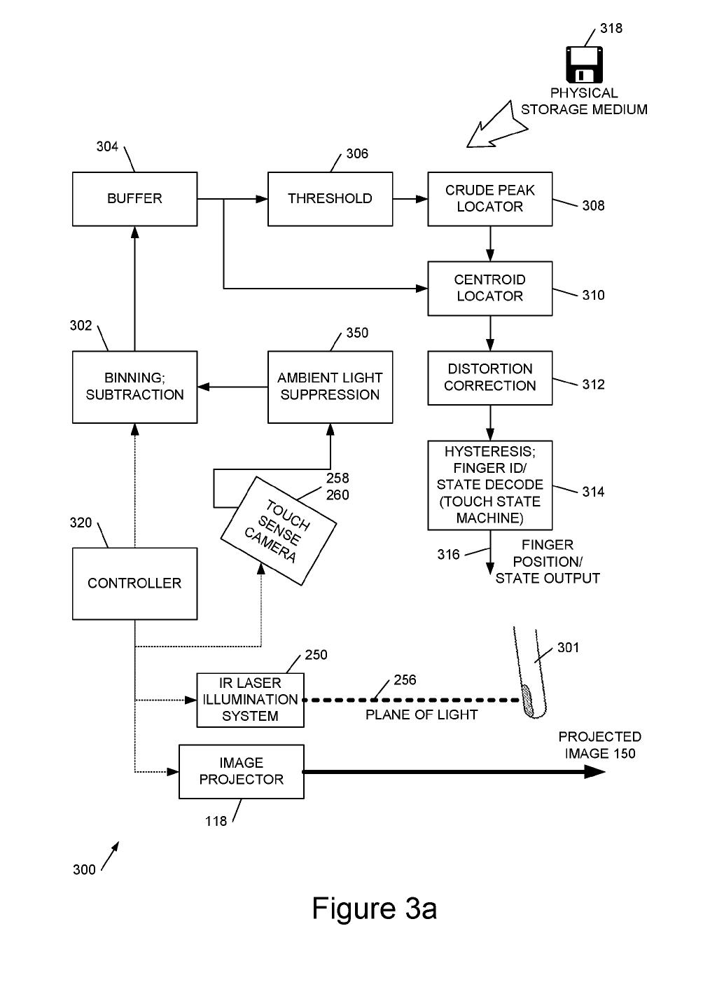

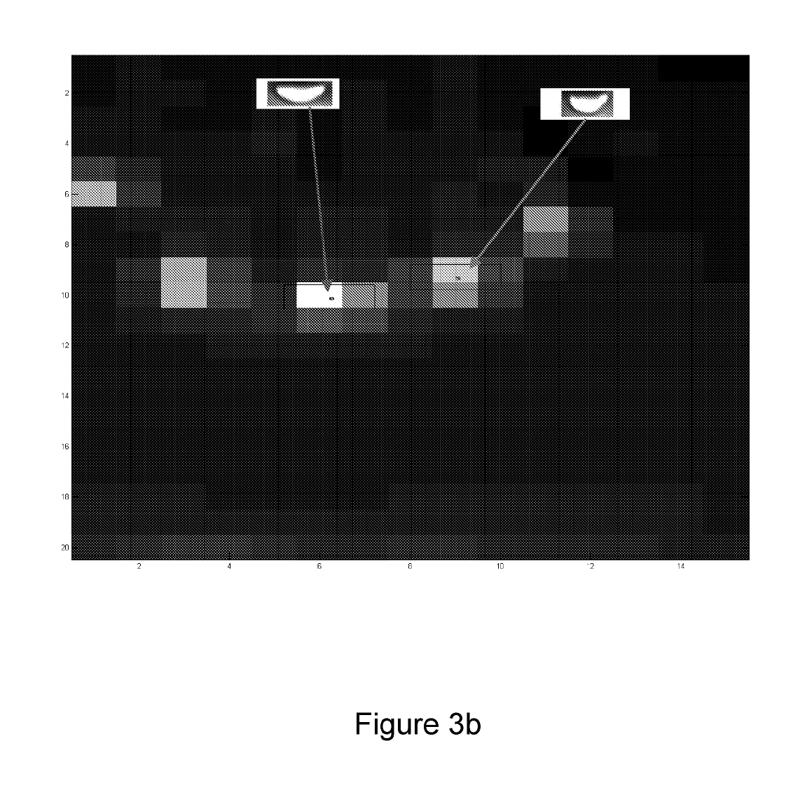

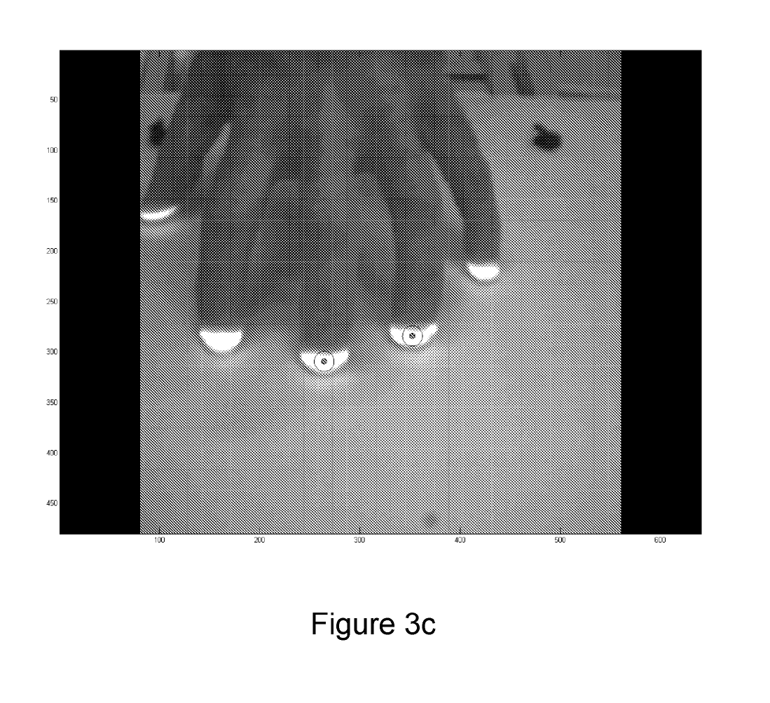

Referring now to FIG. 3a, this shows an embodiment of a touch sensitive image display device 300 according to an aspect of the invention. The system comprises an infra red laser and optics 250 to generate a plane of light 256 viewed by a touch sense camera 258, 260 as previously described, the camera capturing the scattered light from one or more fingers 301 or other objects interacting with the plane of light. The system also includes an image projector 118, for example a holographic image projector, also as previously described, to project an image typically generally in front of the device, in embodiments generally downwards at an acute angle to a display surface.

In the arrangement of FIG. 3a a controller 320 controls the IR laser on and off, controls the acquisition of images by camera 260 and controls projector 118. In the illustrated example images are captured with the IR laser on and off in alternate frames and touch detection is then performed on the difference of these frames to subtract out any ambient infra red. The image capture objects 258 preferably also include a notch filter at the laser wavelength which may be around 780-800 nm. Because of laser diodes process variations and change of wavelength with temperature this notch may be relatively wide, for example of order 20 nm and thus it is desirable to suppress ambient IR. In the embodiment of FIG. 3a subtraction is performed by module 302 which, in embodiments, is implemented in hardware (an FPGA).

In embodiments module 302 also performs binning of the camera pixels, for example down to approximately 80 by 50 pixels. This helps reduce the subsequent processing power/memory requirements and is described in more detail later. However such binning is optional, depending upon the processing power available, and even where processing power/memory is limited there are other options, as described further later. Following the binning and subtraction the captured image data is loaded into a buffer 304 for subsequent processing to identify the position of a finger or, in a multi-touch system, fingers.

Because the camera 260 is directed down towards the plane of light at an angle it can be desirable to provide a greater exposure time for portions of the captured image further from the device than for those nearer the device. This can be achieved, for example, with a rolling shutter device, under control of controller 320 setting appropriate camera registers.

Depending upon the processing of the captured touch sense images and/or the brightness of the laser illumination system, differencing alternate frames may not be necessary (for example, where ‘finger shape’ is detected). However where subtraction takes place the camera should have a gamma of substantial unity so that subtraction is performed with a linear signal.

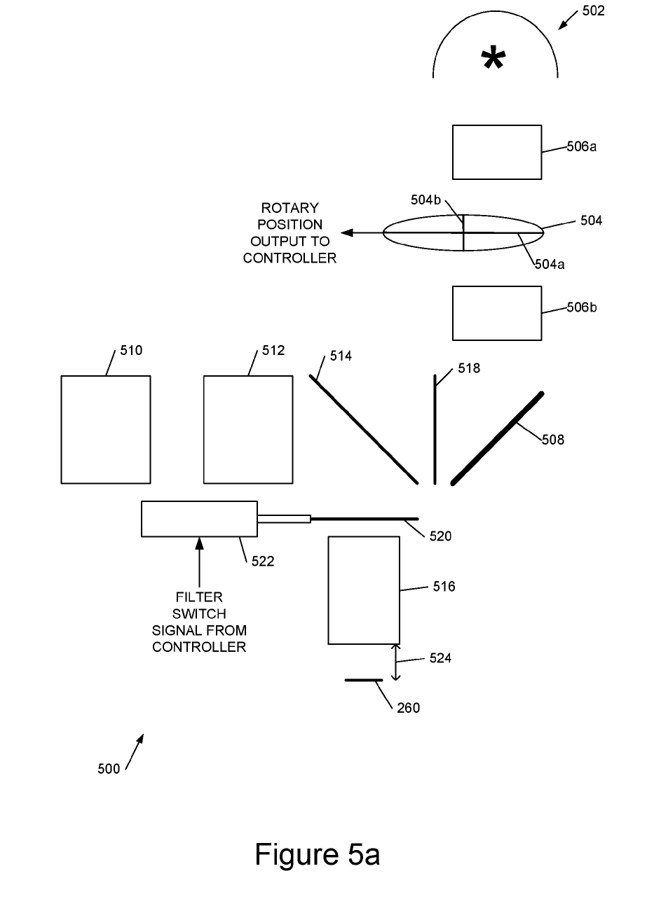

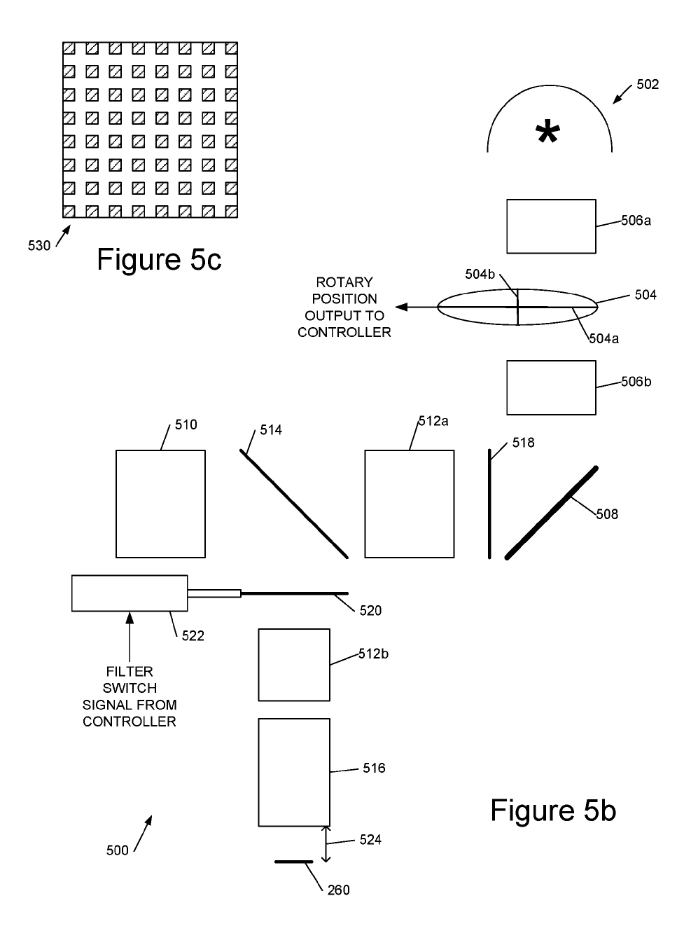

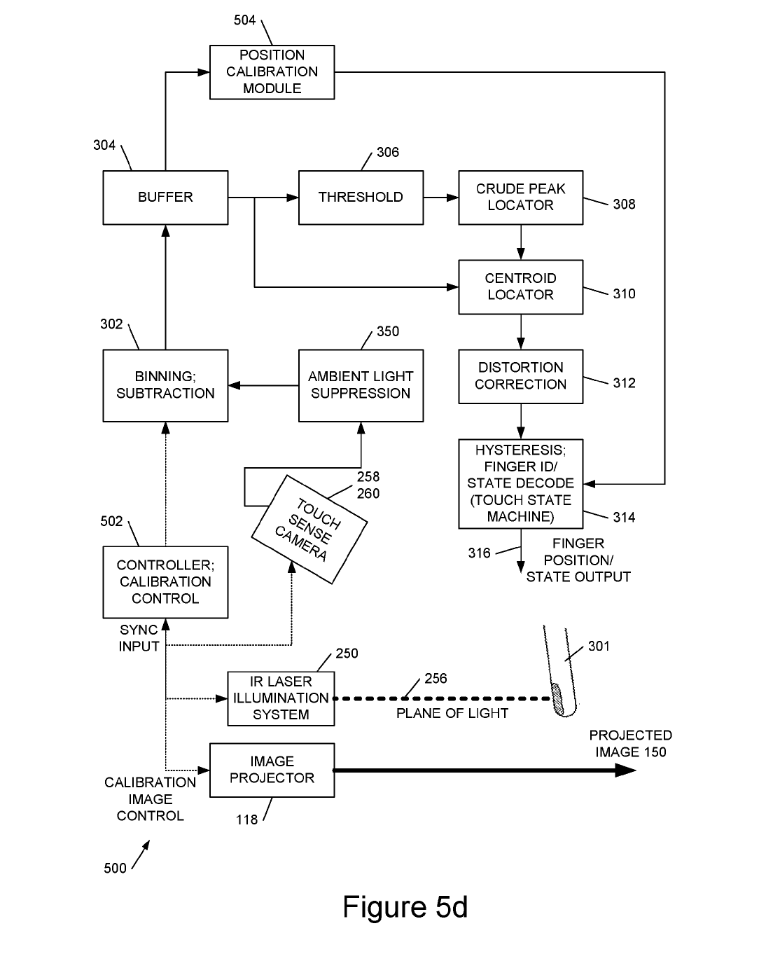

Various different techniques for locating candidate finger/object touch positions will be described. In the illustrated example, however, an approach is employed which detects intensity peaks in the image and then employs a centroid finder to locate candidate finger positions. In embodiments this is performed in software. Processor control code and/or data to implement the aforementioned FPGA and/or software modules shown in FIG. 3 (and also to implement the modules described later with reference to FIG. 5) may be provided on a disk 318 or another physical storage medium.

Thus in embodiments module 306 performs thresholding on a captured image and, in embodiments, this is also employed for image clipping or cropping to define a touch sensitive region. Optionally some image scaling may also be performed in this module. Then a crude peak locator 308 is applied to the thresholded image to identify, approximately, regions in which a finger/object is potentially present.

FIG. 3b illustrates an example such a coarse (decimated) grid. In the Figure the spots indicate the first estimation of the centre-of-mass. We then take a 32×20 (say) grid around each of these. This is preferably used in conjunction with a differential approach to minimize noise, i.e. one frame laser on, next laser off.

A centroid locator 310 (centre of mass algorithm) is applied to the original (unthresholded) image in buffer 304 at each located peak, to determine a respective candidate finger/object location. FIG. 3c shows the results of the fine-grid position estimation, the spots indicating the finger locations found.

The system then applies distortion correction 312 to compensate for keystone distortion of the captured touch sense image and also, optionally, any distortion such as barrel distortion, from the lens of imaging optics 258. In one embodiment the optical access of camera 260 is directed downwards at an angle of approximately 70° to the plane of the image and thus the keystone distortion is relatively small, but still significant enough for distortion correction to be desirable.

Because nearer parts of a captured touch sense image may be brighter than further parts, the thresholding may be position sensitive (at a higher level for minor image parts) alternatively position-sensitive scaling may be applied to the image in buffer 304 and a substantially uniform threshold may be applied.

In one embodiment of the crude peak locator 308 the procedure finds a connected region of the captured image by identifying the brightest block within a region (or a block with greater than a threshold brightness), and then locates the next brightest block, and so forth, preferably up to a distance limit (to avoid accidentally performing a flood fill). Centroid location is then performed on a connected region. In embodiments the pixel brightness/intensity values are not squared before the centroid location, to reduce the sensitivity of this technique to noise, interference and the like (which can cause movement of a detected centroid location by more than once pixel).

A simple centre-of-mass calculation is sufficient for the purpose of finding a centroid in a given ROI (region of interest), and R(x,y) may be estimated thus:

$$x = \frac{{\sum }_{{y}_{S} = 0}^{Y - 1} {\sum }_{{x}_{S} = 0}^{X - 1} {x}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

$$y = \frac{{\sum }_{{y}_{S} = 0}^{Y - 1} {\sum }_{{x}_{S} = 0}^{X - 1} {y}_{S} {R}^{n} ( {x}_{S} , {y}_{S} )}{{\sum }_{{y}_{S} = 0}^{Y - 1} {\sum }_{{x}_{S} = 0}^{X - 1} {R}^{n} ( {x}_{S} , {y}_{S} )}$$

where n is the order of the CoM calculation, and X and Y are the sizes of the ROI.

In embodiments the distortion correction module 312 performs a distortion correction using a polynomial to map between the touch sense camera space and the displayed image space: Say the transformed coordinates from camera space (x,y) into projected space (x′,y′) are related by the bivariate polynomial: x′=xCₓy^{T} x′xCₓy^{T} and y′=xC_{y}y^{T}; where Cₓ and C_{y} represent polynomial coefficients in matrix-form, and x and y are the vectorised powers of x and y respectively. Then we may design Cₓ and C_{y} such that we can assign a projected space grid location (i.e. memory location) by evaluation of the polynomial:

b=└x′┘+X└y′┘

Where X is the number of grid locations in the x-direction in projector space, and └.┘ is the floor operator. The polynomial evaluation may be implemented, say, in Chebyshev form for better precision performance; the coefficients may be assigned at calibration. Further background can be found in our published PCT application WO2010/073024.

Once a set of candidate finger positions has been identified, these are passed to a module 314 which tracks finger/object positions and decodes actions, in particular to identity finger up/down or present/absent events. In embodiments this module also provides some position hysteresis, for example implemented using a digital filter, to reduce position jitter. In a single touch system module 314 need only decode a finger up/finger down state, but in a multi-touch system this module also allocates identifiers to the fingers/objects in the captured images and tracks the identified fingers/objects.

In general the field of view of the touch sense camera system is larger than the displayed image. To improve robustness of the touch sensing system touch events outside the displayed image area (which may be determined by calibration) may be rejected (for example, using appropriate entries in a threshold table of threshold module 306 to clip the crude peak locator outside the image area).

### Auto-Calibration, Synchronization and Optical Techniques

We will now describe embodiments of various techniques for use with a touch sensitive display device, for example of the general type described above. The skilled person will appreciate that the techniques we will describe may be employed with any type of image projection system, not just the example holographic image projection system of FIG. 2.

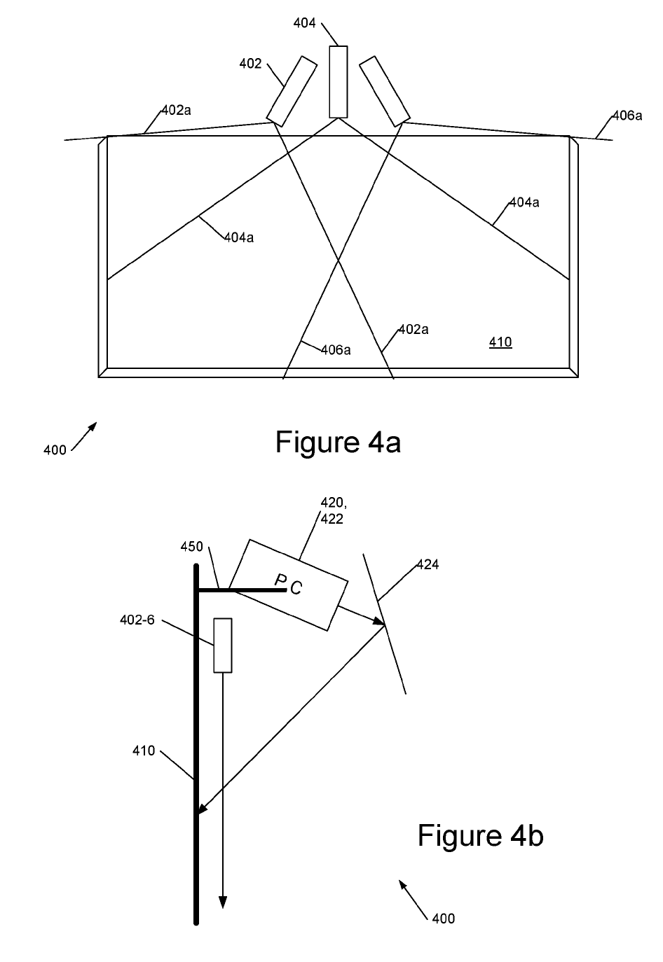

Thus referring to first FIG. 4a, this shows a plan view of an interactive whiteboard touch sensitive image display device 400 including a movement compensation system according to an embodiment of the invention. FIG. 4b shows a side view of the device.

As illustrated there are three IR fan sources 402, 404, 406, each providing a respective light fan 402a, 404a, 406a spanning approximately 120° (for example) and together defining a single, continuous sheet of light just above display area 410. The fans overlap on display area 410, central regions of the display area being covered by three fans and more peripheral regions by two fans and just one fan. This is economical as shadowing is most likely in the central region of the display area. Typical dimensions of the display area 410 may be of order 1 m by 2 m. The side view of the system illustrates a combined projector 420 and touch image capture camera 422 either aligned side-by-side or sharing at least an output portion of the projection optics. As illustrated in embodiments the optical path between the projector/camera and display area is folded by a mirror 424. The sheet of light generated by fans 402a, 404a, 406a is preferably close to the display area, for example less than 1 cm or 0.5 cm above the display area. However the camera and projector 422, 420 are supported on a support 450 and may project light from a distance of up to around 0.5 m from the display area.

We first describe auto-calibration using a calibration pattern projected from projector: The projector itself can project a pattern containing identifiable features in known locations. Examples include a grid of lines, randomly positioned dots, dots in the corners of the image, single dots or lines, crosshairs, and other static or time-varying patterns or structures. If the camera 258, 260 can see this pattern then the system can use this for calibration without any need for manual referencing by the user.

Such auto-calibration may be performed, for example: (1) when an explicit calibration operation is requested by the user; and/or (2) when an explicit calibration operation is triggered by, for example, system startup or shutdown or a long period of inactivity or some automatically-gathered evidence of poor calibration; and/or (3) at regular intervals; and/or (4) effectively continuously.

When implementing this technique the camera is made able to see the light the projector emits. In normal operation the system aims to remove IR from the projector's output and to remove visible light from the camera's input. One or other of these may be temporarily deactivated for auto-calibration. This may be done (a) by physically moving a filter out of place (and optionally swapping in a different filter instead) when calibration is being done; and/or (b) by having a filter or filters move in and out of use all the time, for example using the projector's color wheel or a second “color wheel” applied to the camera; and/or (c) by providing the with camera a Bayer-like filter (FIG. 5c) where some pixels see IR and some pixels see visible light. Such a filter may be combined with an anti-aliasing filter, for example similar to those in consumer digital cameras, so that small features are blurred rather than arbitrarily either seen at full brightness or missed depending on their location relative to the IR/visible filter.

It is also desirable to share at least a portion of the optical path between the imaging optics (projection lens) and the touch camera optics. Such sharing matches distortion between image output and touch input and ameliorates the need for cross-calibration between input and output, since both (sharing optics) are subject to the substantially same optical distortion.

Referring now to FIG. 5a, this shows an embodiment of a touch sensitive image display device 500 arranged to implement an auto-calibration procedure as described above. In the illustrated example an arc lamp 502 provides light via a color wheel 504 and associated optics 506a, b to a digital micro minor device 508. The color wheel 504 sequentially selects, for example, red, green, blue and white but may be modified to include an IR “color” and/or to increase the blanking time between colors by increasing the width of the separators 504a. In other arrangements switched, substantially monochromatic laser or LED illumination is employed instead. The color selected by color wheel 504 (or switched to illuminate the DMD 508) is known by the projector controller but, optionally, a rotation sensor may also be attached to wheel 504 to provide a rotation signal output 504b. A DMD is a binary device and thus each color is built up from a plurality of sub-frames, one for each significant bit position of the displayed image.

The projector is configured to illuminate the display surface at an acute angle, as illustrated in FIG. 5b, and thus the output optics include front end distortion correction optics 510 and intermediate, aspheric optics 512 (with a fuzzy intermediate image in between). The output optics 510, 512 enable short-throw projection onto a surface at a relatively steep angle.

Although the touch sense camera, 258, 260 may simply be located alongside the output optics, preferably the camera is integrated into the projector by means of a dichroic beam splitter 514 located after DMD 508 which dumps IR from lamp 502 and directs incoming IR scattered from the sheet of light into sensor 260 of the touch sense camera via relay optics 516 which magnify the image (because the sensor 260 is generally smaller than the DMD device 508).

The dichroic beam splitter 514 is provided with a substantially non-absorbing dialectric coating, but preferably the system incorporates additional filtering, more particularly a broadband IR reject filter 518 and a notch IR pass filter 520 to filter out unwanted IR from the exterior of the projector/camera system.

Lamp 502 is typically a mercury discharge lamp and thus emits a significant proportion of IR light. This can interfere with the touch detection in two ways: light is transmitted through the projection optics to the screen and reflected back through the camera optics; and IR light is reflected inside the projection optics back to the camera. Both these forms of interference can be suppressed by locating and IR blocking filter before any such light reaches the camera, for example as shown by filter 518 or, alternatively, just before or just after color wheel 504.

Continuing to refer to FIG. 5a, notch filter 520 may be mounted on a mechanical actuator 522 so that the notch filter is switchable into and out of the optical path to sensor 260 under control of the system controller. This allows the camera to see the visible output from the projector when a calibration image is displayed.

Referring to FIG. 5b, this shows an alternative arrangement of the optical components of FIG. 5a, in which like elements are indicated by like reference numerals. In the arrangement of FIG. 5b the aspheric intermediate optics are duplicated 512a, 5, which enables optics 512b to be optimized for distortion correction at the infrared wavelength used by the touch sensing system. By contrast in the arrangement of FIG. 5a the optics 510, 512 are preferably optimized for visible wavelengths since a small amount of distortion in the touch sensing system is generally tolerable.

As illustrated schematically by arrow 524 in FIGS. 5a and 5b, it can be advantageous to defocus the relay optics 516 slightly so that the image on sensor 260 is defocused to reduce problems which can otherwise arise from laser speckle. Such defocus enables improved detection of small touch objects. In embodiments the optics 524 may be modified to add defocus only onto the vertical axis of the sensor (the vertical axis in FIG. 4a).

FIG. 5c illustrates an example Bayer-type spatial filter 530 which may be located directly in front of camera sensor 260 so that some pixels of the sensor see visible light and some IR light. As previously mentioned, if this is done, filter 530 may be combined with an anti-aliasing filter for improved touch detection. Such an anti-aliasing filter may comprise, for example, a pair of layers of birefringent material.

Continuing to refer to the optical configuration and image capture, as previously mentioned the projector may itself be a source of light interference because the camera is directed towards the image display surface (and because where the camera shares optics with the projector there can be other routes for light from the projector to reach the camera. This can cause difficulties, for example, in background subtraction because the light output from the projector varies for several reasons: the projected image varies; the red, green and blue levels may vary even for a fixed image, and in general pass through the filters to the camera in different (small) amounts; and because the projectors imaging panel may be a binary device such as a DMD which switches very rapidly within each frame.

These problems can be ameliorated by synchronizing the capture of the touch sense image with operation of the projector. For example the camera may be triggered by a signal which is referenced to the position of the color wheel (for example derived from the color wheel or the projector controller). Alternatively the image capture rate of the touch sense camera may be arranged to be substantially different to the rate at which the level of interference from the projected image varies. In this case the interference effectively beats at a known difference frequency, which can then be used to reject this light component by digital filtering. Additionally or alternatively, irrespective of whether the previously described techniques are employed, the system may incorporate feedback, providing a signal related to the amount of light in the image displayed by the projector, to the touch system. The touch system may then apply light interference compensation dependent on a level of this signal.

Referring now to FIG. 5d, this shows a system similar to that illustrated in FIG. 3a, but with further details of the calibration processing and control system. Thus the system controller incorporates a calibration control module 502 which is able to control the image projector 118 to display a calibration image. In the illustrated embodiment controller 502 also receives a synchronization input from the projector 118 to enable touch sense image capture to be synchronized to the projector. Optionally in a system where the projector is able to project an IR image for calibration controller 502 may suppress projection of the sheet of light during this interval.

A captured calibration image is processed for ambient light suppression and general initial filtering in the usual way and is then provided to a position calibration module 504 which determines the positions of the reference points in the displayed calibration image and is thus able to precisely locate the displayed image and map identified touch positions to corresponding positions within the displayed image. Thus position calibration module 504 provides output date to the object location detection module 314 so that, if desired, this module is able to output position date referenced to a displayed image.

It will be appreciated that for the touch sensing system to work a user need not actually touch the displayed image. The plane or fan of light is preferably invisible, for example in the infrared, but this is not essential—ultraviolet or visible light may alternatively be used. Although in general the plane or fan of light will be adjacent to displayed image, this is also not essential and, in principle, the projected image could be at some distance beyond the touch sensing surface. The skilled person will appreciate that whilst a relatively thin, flat sheet of light is desirable this is not essential and some tilting and/or divergence or spreading of the beam may be acceptable with some loss of precision. Alternatively some convergence of the beam towards the far edge of the display area may be helpful in at least partially compensating for the reduction in brightness of the touch sensor illumination as the light fans out. Further, in embodiments the light defining the touch sheet need not be light defining a continuous plane—instead structured light such as a comb or fan of individual beams and/or one or more scanned light beams, may be employed to define the touch sheet.

### Touch Image Stabilization

We will now describe embodiments of techniques for touch image stabilization for use with a touch sensitive display device, for example of the general type described above. The skilled person will appreciate that the techniques we will describe may be employed with any type of image projection system, not just the example holographic image projection system of FIG. 2.

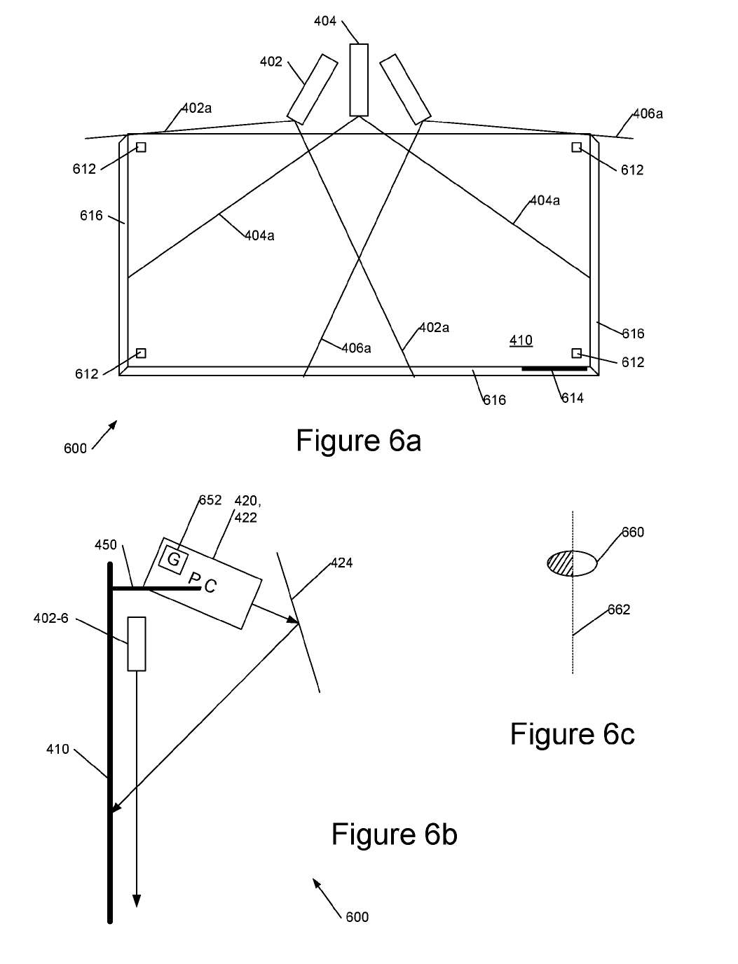

Thus referring to first FIG. 6a, this shows a plan view of an interactive whiteboard touch sensitive image display device 600 including a movement compensation system according to an embodiment of the invention. FIG. 6b shows a side view of the device. Like elements to those of FIGS. 4a and 4b are indicated by like reference numerals to those used previously.

Thus, as illustrated there are three IR fan sources 402, 404, 406, each providing a respective light fan 402a, 404a, 406a spanning approximately 120° (for example) and together defining a single, continuous sheet of light just above display area 410. The fans overlap on display area 410, central regions of the display area being covered by three fans and more peripheral regions by two fans and just one fan. This is economical as shadowing is most likely in the central region of the display area. Typical dimensions of the display area 410 may be of order 1 m by 2 m. The side view of the system illustrates a combined projector 420 and touch image capture camera 422 either aligned side-by-side or sharing at least an output portion of the projection optics. As illustrated in embodiments the optical path between the projector/camera and display area is folded by a mirror 424. The sheet of light generated by fans 402a, 404a, 406a is preferably close to the display area, for example less than 1 cm or 0.5 cm above the display area. However the camera and projector 422, 420 are supported on a support 450 and may project light from a distance of up to around 0.5 m from the display area.

The support may not be particularly rigid, and even if the support does appear to be rigid, when projecting over a large display area there can still be significant movement of the projected image across the display area with relatively flexing of the support and movement of the projector, for example from people walking past, air currents and the like. In a display which is not touch sensitive this is not noticeable but in a touch sensing system of the type we describe an object, say a finger, on the whiteboard moves its effective position with respect to the projected image (the position of which is locked to the camera).

We have described, in our co-pending UK patent application filed on the same day as this application, improved techniques for generating the overlapping fan arrangement defining the sheet of light for the touch sensing. Nonetheless, there can be some discontinuities where a finger or pen overlaps the edge of a fan, as schematically illustrated in FIG. 6c: this shows an object 660 straddling the edge 662 of a fan, indicating that in such a case there may be lighter and darker portions of the object. Further, some light from the sheet of light over the display area can spill onto the display area providing a relatively extended region of increased background light intensity. An ambient light reflection can give rise to a similar effect.

As previously described with reference to FIG. 3a, in embodiments of the signal processing there is a subtraction step to suppress background ambient and other illumination. However movement of the projected image and camera relative to the light sheet can cause this subtraction to fail to operate correctly and generate artifacts because the ambient/spilled light and/or fan edges move.

One strategy which can be employed to address this problem is to incorporate a MEMS gyroscope 652 (FIG. 6b) in or mechanically attached to the projector/camera 420, 422. This can then be used to form image stabilization with respect to the light sheet and, more particularly, the whiteboard surface 410.

In another approach which may be employed separately or in combination with gyroscope-based image stabilization the light sheet is used to generate an input template for the camera 422 by employing one or more features on the whiteboard intersecting the sheet of light. Thus a set of markers 612 (FIG. 6a) may be positioned on the board and/or existing features such as a pen holder 614 or raised bezel 616 of the whiteboard may be employed for this purpose. The markers 612 need not be a permanent feature of the whiteboard and instead one or more of these may simply be attached to the whiteboard at a convenient position by a user.

The input template provides one or more points which are fixed with reference to the display surface and thus may again be employed for stabilization of the touch sensing camera image.

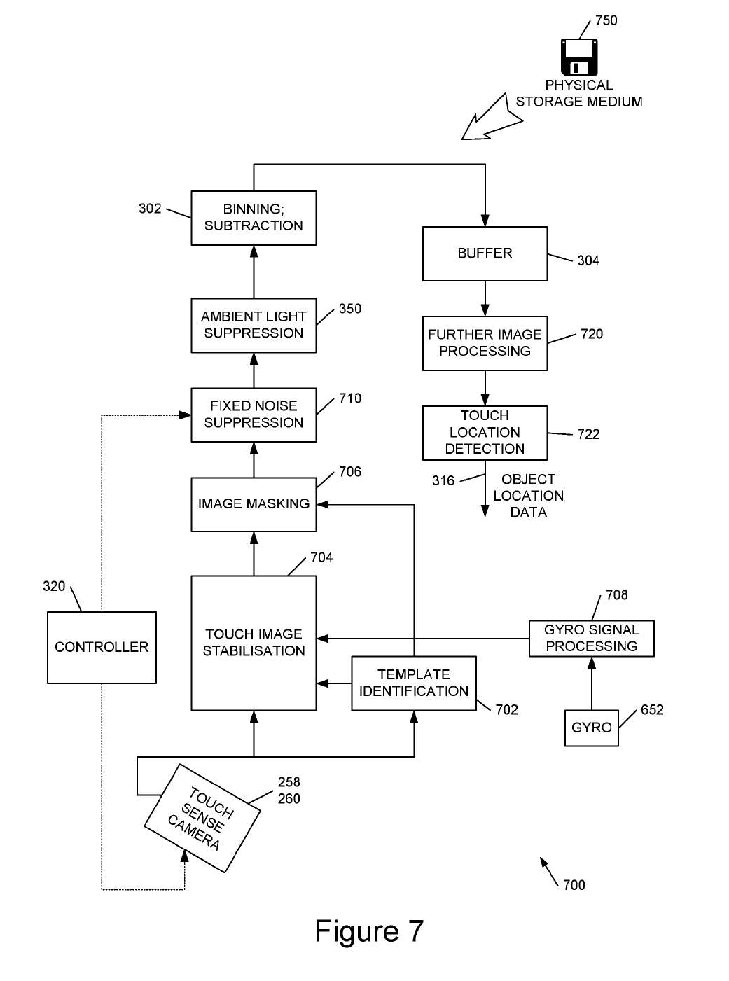

Referring next to FIG. 7, this shows relevant aspects of the image processing for the device 600 of FIG. 6. FIG. 7 is an adaptation of earlier FIG. 3a, omitting some details for clarity, and illustrating the additional signal processing. Again code and/or data to implement some or all of the signal processing modules of FIG. 7 may be provided on a non-transitory carrier medium, schematically illustrated by disk 750.

Thus in FIG. 7 captured image data from camera 258, 260 is provided to an image stabilization module 704, which may be implemented in either hardware or software, for example using an algorithm similar to that employed in a conventional hand held digital camera. Motion data for input to the image stabilization module may be derived from gyro 652 via a gyro signal processing module 708 and/or a template identification module 702 to lock onto the positions of one or more fiducial markers in a captured image, such as markers 612. (Where such a marker is placed by a user there may be an optional calibration step where the marker location is identified, or the marker may, for example, have a characteristic, identifiable image signature).

Additionally or alternatively to touch image stabilization, a defined input template may be employed to mask an image captured from the touch sense camera. Thus embodiments of the signal processing provide an image masking module 706 coupled to the template identification module 702. This may be employed, for example, to define a region beyond which data is rejected. This may be used to reject ambient light reflections and/or light spill and, in embodiments, there may be no need for stabilization under these circumstances, in which case the stabilization module may be omitted. Thus the skilled person will appreciate that embodiments of the invention may incorporate either or both of touch image stabilization and image masking.

A further optional addition to the system is a fixed noise suppression module to suppress a fixed noise pattern from the camera sensor. This may be coupled to controller 320 to capture two images at different exposures, then subtracting a scaled version of one from the other to separate fixed pattern noise from other image features.

The signal processing then proceeds, for example as previously described with reference to FIG. 3a, with ambient light suppression, binning/subtraction, buffering and then further image processing 720 if desired, followed by touch location detection 722.

It will be appreciated that for the touch sensing system to work a user need not actually touch the displayed image. The plane or fan of light is preferably invisible, for example in the infrared, but this is not essential—ultraviolet or visible light may alternatively be used. Although in general the plane or fan of light will be adjacent to displayed image, this is also not essential and, in principle, the projected image could be at some distance beyond the touch sensing surface. The skilled person will appreciate that whilst a relatively thin, flat sheet of light is desirable this is not essential and some tilting and/or divergence or spreading of the beam may be acceptable with some loss of precision. Alternatively some convergence of the beam towards the far edge of the display area may be helpful in at least partially compensating for the reduction in brightness of the touch sensor illumination as the light fans out. Further, in embodiments the light defining the touch sheet need not be light defining a continuous plane—instead structured light such as a comb or fan of individual beams and/or one or more scanned light beams, may be employed to define the touch sheet.

The techniques we have described are particularly useful for implementing an interactive whiteboard although they also have advantages in smaller scale touch sensitive displays. No doubt many other effective alternatives will occur to the skilled person. It will be understood that the invention is not limited to the described embodiments and encompasses modifications apparent to those skilled in the art lying within the spirit and scope of the claims appended hereto.

1. A touch sensitive image display device, the device comprising:
an image projector to project a displayed image onto a display surface;
a touch sensor light source to project light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
wherein said camera is further able to capture an image projected by said image projector;
wherein said image projector is configured to project a calibration image; and
wherein said touch sensitive image display device further comprises a calibration module configured to use a camera image, captured by said camera, of said calibration image to calibrate locations in said captured touch sense image with reference to said displayed image.

2. A touch sensitive image display device as claimed in claim 1 wherein said camera has a controllable wavelength-dependent sensitivity, and wherein said calibration module is configured to control said wavelength-dependent sensitivity between a first wavelength-dependent sensitivity for which said camera is sensitive to said projected light defining said touch sheet and rejects light from said displayed image, and a second wavelength-dependent sensitivity for which said camera is sensitive to light from said displayed image.

3. A touch sensitive image display device as claimed in claim 2 comprising a controllable optical notch filter and a controller to apply said notch filter to said camera for said first wavelength-dependent sensitivity and to remove said notch filter from said camera for said second wavelength-dependent sensitivity.

4. A touch sensitive image display device as claimed in claim 1 wherein said light defining said touch sheet comprises light of a non-visible wavelength, wherein said camera has a wavelength-selective filter to preferentially pass light of said non-visible wavelength and reject light from said displayed image, and wherein said projector is configured to project said calibration image using light of a non-visible wavelength within a passband of said wavelength-selective filter.

5. A touch sensitive image display device as claimed in claim 1 wherein said light defining said touch sheet of light comprises light of a non-visible wavelength, and wherein said camera has a spatially patterned wavelength-selection filter, wherein said spatially patterned wavelength-selection filter is configured to preferentially pass light of said non-visible wavelength and reject light from said displayed image for selected spatial regions of said camera image.

6. A touch sensitive image display device as claimed in claim 5 further comprising an anti-aliasing filter for said wavelength-selective filter.

7. A touch sensitive image display device as claimed in any preceding claim wherein said camera and said image projector share at least part of front-end image projection/capture optics of the device.

8. A method of calibrating a touch sensitive image display device, the method comprising displaying an image by:
projecting a displayed image onto a surface using an image projector;
projecting IR light defining a touch sheet above said displayed image;
capturing a touch sense image from a region including at least a portion of said touch sheet, said touch sense image comprising light scattered from said touch sheet by an object approaching said displayed image using a camera with an IR filter to admit said scattered light and reject light from said displayed image; and
processing said touch sense image to identify a location of said object relative to said displayed image; the method further comprising:
projecting a calibration image using said image projector;
capturing said calibration image using said camera; and
calibrating said location of said object with reference to said reference image using said captured calibration image.

9. A method as claimed in claim 8 wherein said capturing of said calibration image comprises controlling said IR filter to modify a wavelength sensitivity of said camera.

10. A method as claimed in claim 8 comprising projecting said calibration image using IR wavelength light.

11. A method as claimed in claim 8 comprising spatially patterning said IR filter to enable said camera to detect both said scattered light and said displayed image at different locations within a captured image.

12. A device/method as claimed in any preceding claim wherein a said location is calibrated from said calibration image without the need to touch said calibration image.

13. A device/method as claimed in any preceding claim wherein said image projector is configured to project said displayed image as a set of sequential sub-frames, at a sub-frame rate, wherein said sub-frames combine to give the visual impression of said displayed image; and wherein capture of said touch sense images is synchronised to said sub-frame projection.

14. A device/method as claimed in any preceding claim wherein said image projector is configured to project said displayed image as a set of sequential sub-frames, at a sub-frame rate, wherein said sub-frames combine to give the visual impression of said displayed image; and wherein capture of said touch sense images operates at a frequency different by a factor of at least ten from said sub-frame rate.

15. A device/method as claimed in any preceding claim wherein said camera comprises image capture optics configured to capture said touch sense image from an acute angle relative to said touch sheet; wherein said image projector is configured to project onto said surface at an acute angle and comprises an imaging device illuminated by a display light source, and distortion correction optics between said imaging device and a light projection output of said image projector; and wherein an optical path between said imaging device and said distortion correction optics includes a dichroic beam splitter to optically couple said camera into a shared optical path for both said projector and said camera through said distortion correction optics to said light projection output.

16. A touch sensitive image display device, the device comprising:
an image projector to project a displayed image onto a surface;
a touch sensor light source to project light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
wherein said image projector is configured to project said displayed image as a set of sequential sub-frames, at a sub-frame rate, wherein said sub-frames combine to give the visual impression of said displayed image; and
wherein capture of said touch sense images is synchronised to said sub-frame projection.

17. A touch sensitive image display device as claimed in claim 13 or 16 wherein said sequential projection of said sub-frames includes blanking intervals between at least some of said sub-frames; and wherein capture of said touch sense images is synchronised to said blanking intervals.

18. A touch sensitive image display device as claimed in claim 13, 16 or 17 wherein said image projector comprises a digital multimirror imaging device illuminated via changing colour illumination system in particular a spinning colour wheel, and wherein said image capture is triggered responsive to an illumination colour of said changing colour illumination system, in particular a rotational position of said colour wheel.

19. A touch sensitive image display device, the device comprising:
an image projector to project a displayed image onto a surface;
a touch sensor light source to project light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
wherein said image projector is configured to project said displayed image as a set of sequential sub-frames, at a sub-frame rate, wherein said sub-frames combine to give the visual impression of said displayed image; and
wherein capture of said touch sense images operates at a frequency different by a factor of at least ten from said sub-frame rate.

20. A touch sensitive image display device, the device comprising:
an image projector to project a displayed image onto a surface;
a touch sensor light source to project light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
wherein said image projector is configured to project onto said surface at an acute angle and comprises an imaging device illuminated by a display light source, and distortion correction optics between said imaging device and a light projection output of said image projector;
wherein said camera comprises image capture optics configured to capture said touch sense image from an acute angle relative to said touch sheet; and
wherein an optical path between said imaging device and said distortion correction optics includes a dichroic beam splitter to optically couple said camera into a shared optical path for both said projector and said camera through said distortion correction optics to said light projection output.

21. A touch sensitive image display device as claimed in claim 15 or 20 wherein said light defining said touch sheet comprises monochromatic IR light; wherein said optical path further comprises an IR reject filter between said imaging device and said dichroic beam splitter; and wherein an optical path between said dichroic beam splitter and said camera comprises an IR transmit notch filter at a wavelength of said monochromatic IR light.

22. A touch sensitive image display device as claimed in claim 15 or 21 further comprising relay optics between said dichroic beam splitter and said camera, wherein said distortion correction optics have focus optimised for a wavelength in the range 400 nm to 700 nm, and wherein said relay optics are optimised for said wavelength of said monochromatic IR light.

23. A touch sensitive image display device as claimed in claim 15, 20, 21 or 22 wherein an image of said scattered light on an image sensor of said camera is defocused.

24. A touch sensitive image display device as claimed in claim 15, 20, 21, 22, or 23 comprising duplicated intermediate optics, wherein a first set of said intermediate optics is located in said optical path between said imaging device and said distortion correction optics, wherein a second set of said intermediate optics is located between said dichroic beam splitter and said camera; and wherein said first and second sets of intermediate optics are optimised for different optical wavelengths.

25. A touch sensitive image display device as claimed in any one of claims 15 and 20 to 24 wherein said imaging device is a digital micromirror device (DMD).

26. A touch sensitive image display device, the device comprising:
an image projector to project a displayed image onto a display surface;
a touch sensor light source to project a light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image; and
further comprising a movement compensation system to compensate for relative movement between said camera and said display surface.

27. A touch sensitive image display device as claimed in claim 26 wherein said camera to said image projector are mechanically coupled to one another such that a field of view of said camera moves in tandem with said displayed image.

28. A touch sensitive image display device as claimed in claim 27 wherein said movement compensation system comprises a motion sensor mechanically coupled to said camera or image projector and having a motion sense signal output, and wherein said signal processor includes a motion compensation module coupled to said output of said motion sensor to compensate said identified location for said relative movement.

29. A touch sensitive image display device as claimed in claim 28 wherein said motion sensor comprises a MEMS gyroscope.

30. A touch sensitive image display device as claimed in any one of claims 26 to 29 wherein said signal processor comprises an input template detection module configured to detect an input template projected onto said display surface by said touch sensor light source; and a motion compensation module, coupled to an output of said template detection module, to compensate for said relative movement.

31. A touch sensitive image display device as claimed in claim 30 wherein said motion compensation module is configured to compensate said identified location for said relative movement.

32. A touch sensitive image display device as claimed in claim 30 or 31 wherein said motion compensation module is configured to compensate a location of a background calibration frame for said relative movement.

33. A touch sensitive image display device as claimed in claim 30 or 31 further comprising a system to attenuate fixed pattern camera noise from a said captured image.

34. A touch sensitive image display device as claimed in claim 30, 31, 32 or 33 wherein said signal processor further comprises a masking module to apply a mask to one or both of an image derived from said captured touch sense image and a said location of said object, to reject putative touch events outside said mask; wherein said mask is located responsive to said input template.

35. A touch sensitive image display device as claimed in any one of claims 30 to 34 in combination with said display surface, wherein said display surface is configured to intersect said light defining said touch sheet at one or more points to define said input template.

36. An interactive whiteboard comprising the touch sensitive image display device of any preceding claim, wherein said camera is mounted on a support and displaced away from plane of said whiteboard, and wherein said relative motion is relative motion arising from movement of said camera on said support.

37. A signal processor for the touch sensitive image display device or interactive whiteboard of any one of claims 26 to 36, the signal processor being configured to process a said touch sense image from said camera to identify a location of said object relative to said displayed image, the signal processor further comprising an input to receive a signal responsive to relative movement between said camera and said display surface, and a system to process said signal to compensate for said relative movement when determining said location of said object.

38. A method of touch sensing in a touch sensitive image display device, the method comprising:
projecting a displayed image onto a surface;
projecting a light defining a touch sheet above said displayed image;
capturing a touch sense image from a region including at least a portion of said touch sheet, said touch sense image comprising light scattered from said touch sheet by an object approaching said displayed image; and
processing said touch sense image to identify a location of said object relative to said displayed image;
the method further comprising compensating for relative movement between said camera and said display surface.

39. A touch sensitive image display device, the device comprising:
an image projector to project a displayed image onto a display surface;
a touch sensor light source to project a light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
wherein said signal processor further comprises an input template detection module configured to detect an input template projected onto said display surface by said touch sensor light source; and
a masking module to apply a mask to one or both of an image from said camera and a said location of said object to reject putative touch events outside said mask; and
wherein said signal processor is configured to determine a location for said mask location responsive to said detected input template.

40. A touch sensitive image display device as claimed in claim 39 configured to apply said mask to a background calibration frame of said touch sensitive image display device.

41. A touch sensitive image display device as claimed in claim 39 or 40 configured to apply said mask to an image derived from said captured touch sense image.

42. A method of rejecting one or both of reflected ambient light and light spill from a touch sensor light source in a touch sensitive image display device, the touch sensitive image display device comprising:
an image projector to project a displayed image onto a display surface;
a touch sensor light source to project light defining a touch sheet above said displayed image;
a camera directed to capture a touch sense image from a region including at least a portion of said touch sheet, said touch sense image comprising light scattered from said touch sheet by an object approaching said displayed image; and
a signal processor coupled to said camera, to process a said touch sense image from said camera to identify a location of said object relative to said displayed image;
the method comprising:
using said light defining said touch sheet to illuminate one or more features projecting from said display surface to thereby define an input template;
using a location of said input template to define a mask to apply to one or both of an image captured from said camera and a said identified object location; and
applying said mask to one or both of an image captured from said camera and a said identified object location to reject one or both of reflected ambient light and light spill onto said display surface from said light defining said touch sheet.

43. A method as claimed in claim 42 used to provide an interactive whiteboard, wherein said features comprise one or more physical features of said whiteboard.
